(19) United States
(12) Patent Application Publication
(10) Pub. No.: US 2015/0171546 A1
(43) Pub. Date: Jun. 18, 2015

(54) FEMALE TERMINAL

(71) Applicant: Yazaki Corporation, Tokyo (JP)

(72) Inventor: Hidenori KIBUSHI, Makinohara-shi (JP)

(73) Assignee: Yazaki Corporation, Tokyo (JP)

(21) Appl. No.: 14/630,930

(22) Filed: Feb. 25, 2015

Related U.S. Application Data
(63) Continuation of application No. PCT/JP2013/071667, filed on Aug. 9, 2013.

(30) Foreign Application Priority Data
Sep. 3, 2012 (JP) 2012-193137

(51) Int. Cl. H01R 13/533; H01R 13/11

(52) U.S. Cl. CPC H01R 13/533; H01R 13/11

(57) ABSTRACT

A female terminal includes a wall portion defining a terminal housing space into which a mating male terminal is inserted, a cantilever plate spring portion including a base end fixed to the wall portion and a free end on the tip side projecting into the terminal housing space, and a wall surface-side fulcrum portion and a spring-side fulcrum portion each having an arc-like surface provided on the wall portion and the plate spring portion, respectively, and each protruding to the other side of the wall portion and the plate spring portion at a position closer to the free end than the base end.

### CROSS REFERENCE TO RELATED APPLICATIONS

This application is a continuation of International Application No. PCT/JP2013/071667, filed Aug. 9, 2013, and based upon and claims the benefit of priority from Japanese Patent Application No. 2012-193137 filed Sep. 3, 2012, the entire contents of all of which are incorporated herein by reference.

### TECHNICAL FIELD

The present application relates to a female terminal provided therein with a plate spring portion that comes into contact with a male terminal.

### BACKGROUND ART

There have been various suggestions made to prevent a decrease in connection reliability between a male terminal and a female terminal in a case of vibration (for example, vibration in a vehicle).

With regard to a male terminal, for example, there is known a technique for enabling a male terminal to follow vibration in various directions (for example, in a vertical direction and in a width direction) (refer to JP 2010-015871 A). With regard to a female terminal, an example thereof is explained below with reference to FIG. 1.

As illustrated in FIG. 1, a conventional female terminal 100 includes a wall portion 110 (a bottom wall 111, an upper wall 112, and both side walls (not illustrated)) defining a terminal housing space 101 into which a mating male terminal 103 is inserted, and a cantilever plate spring portion 120 including a base end 121 A fixed to the upper wall 112 and a free end 121B on the tip side projecting into the terminal housing space 101.

Once the male terminal 103 is inserted into the terminal housing space 101 of the female terminal 100, the plate spring portion 120 is subjected to bend deformation to turn about the base end 121A, and the plate spring portion 120 then comes into contact with the male terminal 103 due to restoring force of the bend deformation.

### SUMMARY

As described above, the technique for dealing with vibration caused on the male terminal has been developed; however, the technique for dealing with vibration caused on the female terminal 100 has not been developed yet. Namely, when vibration is applied to the male terminal 103, the plate spring portion 120 is also vibrated in association therewith, but the plate spring portion 120 does not easily follow the movement of the male terminal. As a result, a contact load between the male terminal 103 and the plate spring portion 120 is unevenly applied, which may lead to a decrease in connection reliability between the male terminal 103 and the female terminal 100.

The present invention has been made in order to solve the above-mentioned problem. An object of the present invention is to provide a female terminal enabling a plate spring portion to easily follow a movement of a male terminal so as to improve connection reliability between the plate spring portion and the male terminal.

In order to solve the above-mentioned problem, a female terminal according to a first aspect of the present invention includes: a wall portion defining a terminal housing space into which a mating male terminal is inserted; a cantilever plate spring portion including a base end fixed to the wall portion and a free end on a tip side projecting into the terminal housing space; and an arc-like fulcrum portion provided on at least one of the wall portion and the plate spring portion and protruding to the other side of the wall portion and the plate spring portion at a position closer to the free end than the base end.

The fulcrum portion preferably includes a wall surface-side fulcrum portion provided on the wall portion and a spring-side fulcrum portion provided on the plate spring portion, and the wall surface-side fulcrum portion is preferably in contact with the spring-side fulcrum portion.

A fixed contact portion protruding toward the terminal housing space is preferably provided on a side opposed to the wall portion provided with the plate spring portion, and the fixed contact portion is preferably formed to have an arc-like surface.

In the female terminal according to the first aspect of the present invention, the arc-like fulcrum portion is provided on at least one of the wall portion and the plate spring portion. Once the male terminal is inserted into the terminal housing space, the plate spring portion is subjected to bend deformation to turn about the fulcrum portion, and the plate spring portion then comes into contact with the male terminal due to restoring force of the bend deformation. When vibration (for example, vibration in a vehicle) is applied to the male terminal, the plate spring portion is also vibrated in association therewith and then turns about the arc-like fulcrum portion so that the plate spring portion can follow the vibration in three-dimensional directions. Accordingly, connection reliability between the male terminal and the plate spring portion is improved.

### BRIEF DESCRIPTION OF DRAWINGS

FIG. 1 is a cross-sectional view illustrating a state of connection between a female terminal of a conventional example and a male terminal.

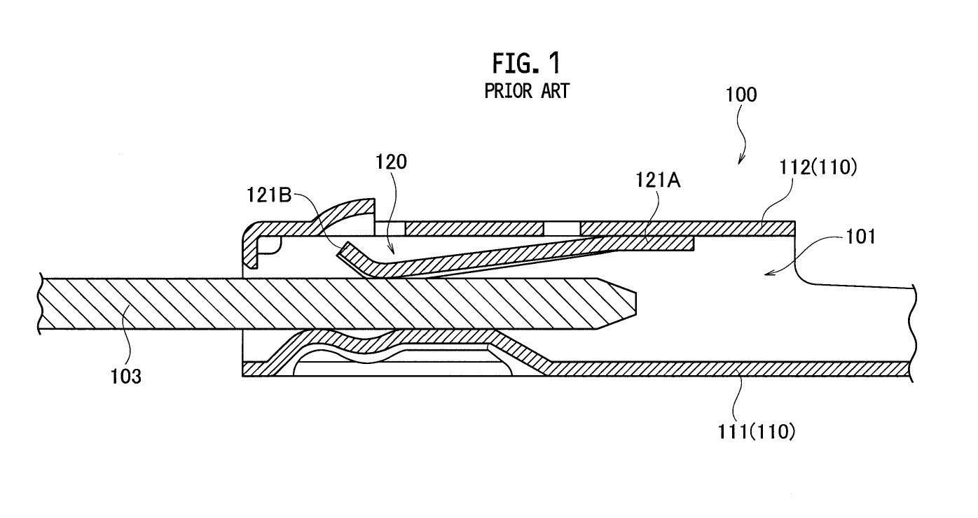

FIG. 2 is a perspective view illustrating a female terminal according to an embodiment.

FIG. 3 is a cross-sectional view taken along line A-A in FIG. 2.

FIG. 4A is a cross-sectional view taken along line B-B in FIG. 2, and FIG. 4B is a cross-sectional view taken along line C-C in FIG. 2.

FIG. 5A is a cross-sectional view illustrating a female terminal according to a modified example, and FIG. 5B is a perspective view illustrating part of a plate spring portion of the female terminal according to the modified example.

### DESCRIPTION OF EMBODIMENTS

A female terminal according to an embodiment will be explained below with reference to the drawings. Here, the same or similar elements in the following explanations of the drawings are indicated by the same or similar reference numerals. It should be noted that the respective elements are schematically illustrated in the drawings, and dimensional ratios in the drawings are different from actual ratios. The specific dimensions thus should be taken into consideration in accordance with the following explanations. In addition, the respective drawings may include the elements which are equivalent but differ in dimensional ratio.

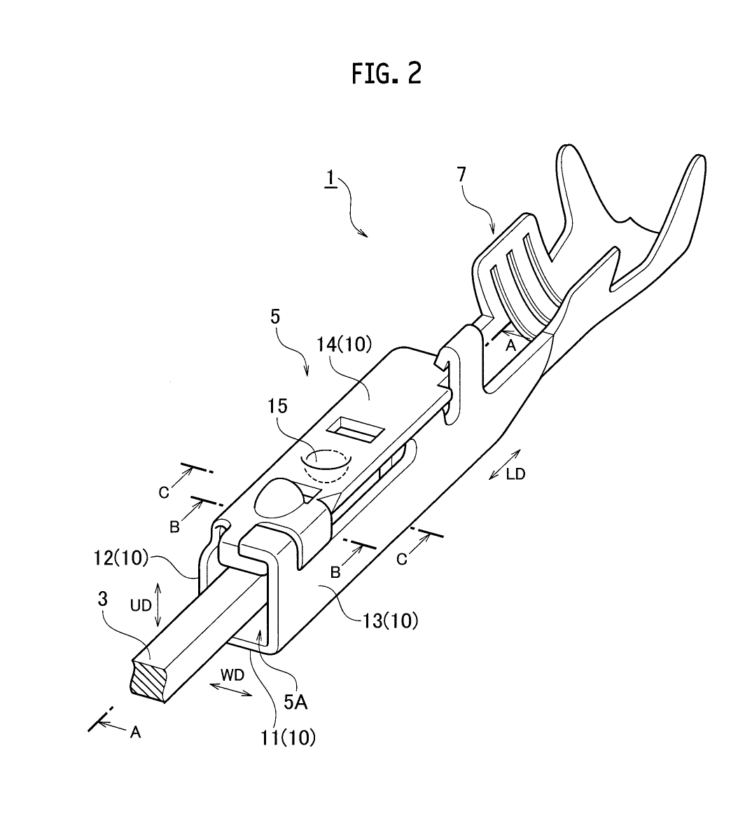

A configuration of a female terminal 1 according to the embodiment is explained below with reference to FIGS. 2 to 4.

The female terminal 1 includes a box-shaped terminal connecting portion 5 into which a male terminal 3 is inserted, and an electric wire fixing portion 7 provided on the rear side of the terminal connecting portion 5 so that an electric wire (not illustrated) is fixed thereto.

The terminal connecting portion 5 includes a wall portion 10 defining a terminal housing space 5A into which the mating male terminal 3 is inserted, an elastic plate spring portion 20 that comes into contact with the male terminal 3, and a fixed contact portion 30 opposed to the plate spring portion 20 to support the male terminal 3.

The wall portion 10 includes a bottom wall 11, a first side wall 12 and a second side wall 13 connected to the bottom wall 11 on both sides thereof, and an upper wall 14 connected to the first side wall 12 and opposed to the bottom wall 11.

The bottom wall 11 is opposed to the upper wall 14. The bottom wall 11 is provided with the fixed contact portion 30. The upper wall 14 is provided with a wall surface-side fulcrum portion 15 in contact with a spring-side fulcrum portion 22 of the plate spring portion 20.

The wall surface-side fulcrum portion 15 protrudes toward the plate spring portion 20. The wall surface-side fulcrum portion 15 is formed to have an arc-like surface in cross section in longitudinal direction LD of the female terminal 1 and formed to have an arc-like surface in cross section in width direction WD of the female terminal 1. Thus, in the female terminal 1 according to the embodiment, the wall surface-side fulcrum portion 15 is formed into a hemispheric shape.

The plate spring portion 20 is provided toward the upper wall 14. The plate spring portion 20 includes a base end 21A fixed to the upper wall 14 and a free end 21B on the tip side of the plate spring portion 20. The free end 21B is formed into a cantilevered shape projecting into the terminal housing space 5A. The plate spring portion 20 is provided with the spring-side fulcrum portion 22 protruding toward the upper wall 14 at a position closer to the free end 21B than the base end 21A.

The spring-side fulcrum portion 22 is located to be opposed to the wall surface-side fulcrum portion 15 and is in contact therewith. The spring-side fulcrum portion 22 is formed to have an arc-like surface in cross section in the longitudinal direction LD of the female terminal 1 and formed to have an arc-like surface in cross section in the width direction WD of the female terminal 1. Thus, in the female terminal 1 according to the embodiment, the spring-side fulcrum portion 22 is formed into a hemispheric shape as in the case of the wall surface-side fulcrum portion 15.

The fixed contact portion 30 is provided on the bottom wall 11 opposed to the upper wall 14 provided with the plate spring portion 20 and protrudes toward the terminal housing space 5A. The fixed contact portion 30 is formed to have an arc-like surface in cross section in the width direction WD of the female terminal 1.

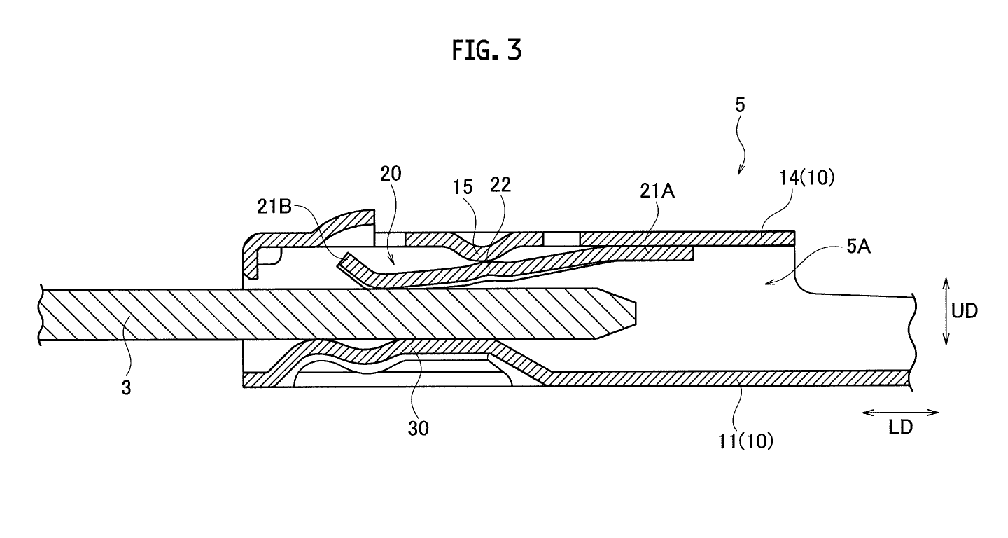

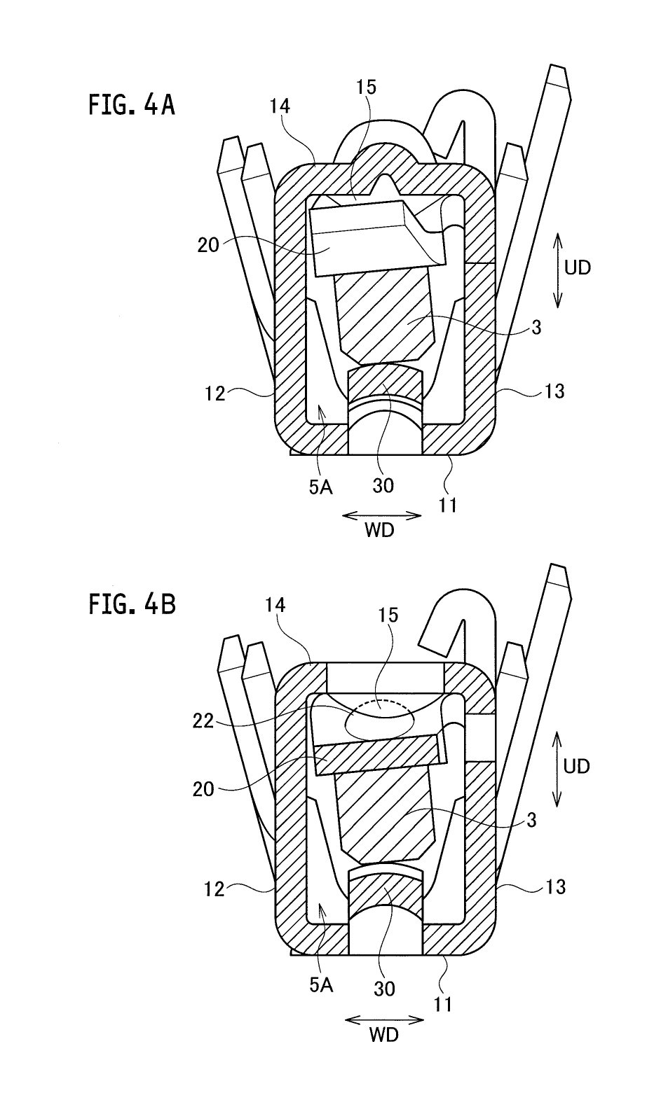

Next, the connection between the female terminal 1 and the male terminal 3 is briefly explained below with reference to FIGS. 3 and 4.

Once the male terminal 3 is inserted into the terminal housing space 5A of the female terminal 1, the plate spring portion 20 is subjected to bend deformation to turn about the spring-side fulcrum portion 22, and the plate spring portion 20 then comes into contact with the male terminal 3 due to restoring force of the bend deformation. Here, the male terminal 3 is held between the plate spring portion 20 and the fixed contact portion 30, and the spring-side fulcrum portion 22 is in contact with the wall surface-side fulcrum portion 15.

When vibration (for example, vibration in a vehicle) is applied to the male terminal 3, the plate spring portion 20 is also vibrated in association therewith and then turns about the spring-side fulcrum portion 22 having an arc-like surface, so that the plate spring portion 20 can follow the vibration in three-dimensional directions. That is, the plate spring portion 20 follows the vibration in several directions (three-dimensional directions) including the vertical direction UD, the width direction WD and the oblique direction (not illustrated) of the female terminal 1.

Further, as illustrated in FIGS. 4A and 4B, the arc-like surface of the fixed contact portion 30 enables the male terminal 3 to move smoothly so that a contact load between the male terminal 3 and the plate spring portion 20 is easily equalized.

As described above, in the female terminal 1 according to the embodiment, the upper wall 14 is provided with the wall surface-side fulcrum portion 15 having an arc-like surface, and the plate spring portion 20 is provided with the spring-side fulcrum portion 22 having an arc-like surface. Thus, when vibration (for example, vibration in a vehicle) is applied to the male terminal 3, the plate spring portion 20 is also vibrated in association therewith and then turns about the spring-side fulcrum portion 22, so that the plate spring portion 20 can follow the vibration in the three-dimensional directions. Accordingly, connection reliability between the male terminal 3 and the plate spring portion 20 is improved.

In the female terminal 1 according to the embodiment, the wall surface-side fulcrum portion 15 is in contact with the spring-side fulcrum portion 22 so that the plate spring portion 20 can easily follow the movement of the male terminal 3 in a wider range.

In the female terminal 1 according to the embodiment, since the fixed contact portion 30 is formed to have an arc-like surface, the fixed contact portion 30 can also follow the movement of the male terminal 3 in the three-dimensional directions so as to further improve the connection reliability between the male terminal 3 and the plate spring portion 20.

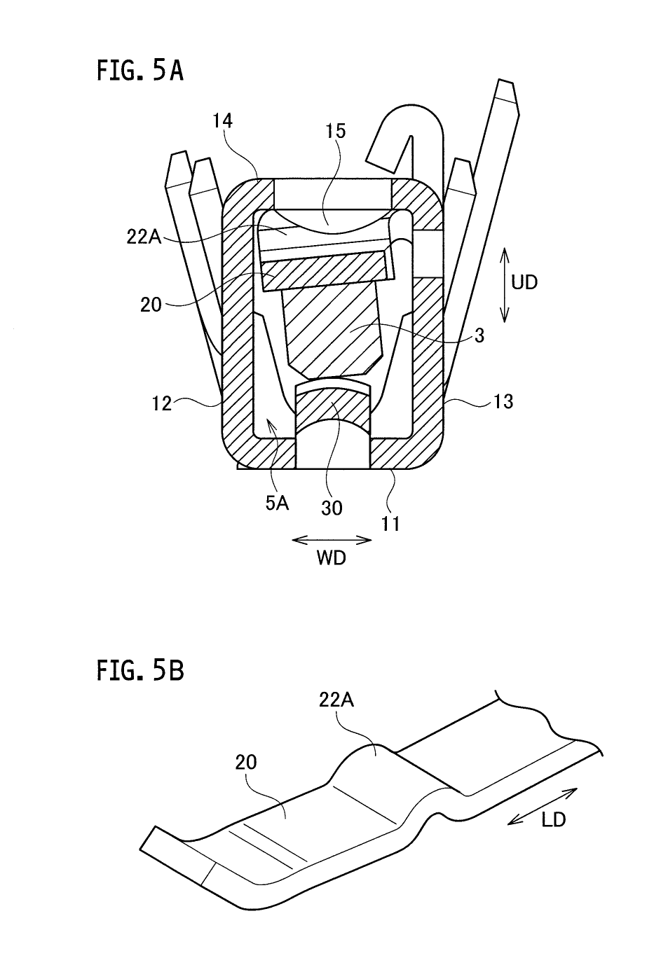

Next, a modified example of the female terminal 1 according to the embodiment is explained with reference to FIGS. 5A and 5B. With regard to the female terminal according to the modified example illustrated in FIGS. 5A and 5B, the same elements as those of the female terminal 1 according to the embodiment are indicated by the same reference numerals, and different configurations are mainly explained below.

The female terminal according to the modified example includes a spring-side fulcrum portion 22A having a different shape from that in the female terminal 1 according to the embodiment. In particular, the spring-side fulcrum portion 22A is elongated in the width direction WD of the female terminal 1. In the female terminal according to the modified example, the spring-side fulcrum portion 22A of the plate spring portion 20 is formed to have an arc-like surface in cross section in the longitudinal direction LD, as in the case of the female terminal 1 according to the embodiment.

In the female terminal according to the modified example, the plate spring portion 20 also easily follows the movement of the male terminal 3 in several directions, as in the case of the female terminal 1 according to the embodiment, so as to improve connection reliability between the male terminal 3 and the plate spring portion 20.

Although the details of the present invention have been disclosed by way of the embodiments described above, the present invention should not be deemed to be limited to the descriptions and the drawings composing part of the disclosure. It will be apparent to those skilled in the art from the disclosure that various alternative embodiments, examples and implementations can be made.

The embodiment of the present invention may be modified as follows. For example, the embodiment exemplified the case where the female terminal 1 is provided with the wall surface-side fulcrum portion 15 and the spring-side fulcrum portion 22, but the embodiment is not limited thereto as long as the female terminal 1 is provided with at least one of the wall surface-side fulcrum portion 15 and the spring-side fulcrum portion 22.

In addition, the embodiment exemplified the case where the free end 21B of the plate spring portion 20 is provided on the tip side from which the male terminal 3 is inserted on the opposite side of the base end 21A but is not limited thereto, and the free end 21B may be provided on the rear side of the base end 21A to which the male terminal 3 is inserted.

In addition, the embodiment exemplified the case where the plate spring portion 20 is provided toward the upper wall 14 but is not limited thereto, and the plate spring portion 20 may be provided toward the bottom wall 11, the first side wall 12, or the second side wall 13. In such a case, the fixed contact portion 30 is not necessarily provided on the bottom wall 11 as long as the fixed contact portion 30 is provided on a surface opposed to a surface provided with the plate spring portion 20.

In addition, the embodiment exemplified the case where the fixed contact portion 30 is formed to have an arc-like surface but is not limited thereto, and the fixed contact portion 30 may be formed to have, for example, a flat surface.

The present invention can, of course, include various embodiments not described in this specification. Therefore, the scope of the present invention is defined only by the appropriate features according to the claims in view of the explanations made above.

What is claimed is:

1. A female terminal, comprising:
a wall portion defining a terminal housing space into which a mating male terminal is inserted;
a cantilever plate spring portion including a base end fixed to the wall portion and a free end on a tip side projecting into the terminal housing space; and
an arc-like fulcrum portion provided on at least one of the wall portion and the plate spring portion and protruding to the other side of the wall portion and the plate spring portion at a position closer to the free end than the base end.

2. The female terminal according to claim 1, wherein:
the fulcrum portion comprises a wall surface-side fulcrum portion provided on the wall portion and a spring-side fulcrum portion provided on the plate spring portion; and
the wall surface-side fulcrum portion is in contact with the spring-side fulcrum portion.

3. The female terminal according to claim 1, wherein
a fixed contact portion protruding toward the terminal housing space is provided on a side opposed to the wall portion provided with the plate spring portion, and
the fixed contact portion is formed to have an arc-like surface.
